(19) United States
(12) Patent Application Publication
(10) Pub. No.: US 2017/0316326 A1
(43) Pub. Date: Nov. 2, 2017

(54) SYSTEM AND METHOD FOR AUTOMATED DECISION MAKING

(71) Applicant: IMPACT RI LIMITED, Woodstock (GB)

(72) Inventors: Mark Steven Ricketts, Woodstock (GB); Jonathan Richard Fielder-White, Woodstock (GB); Denise Barnes, Woodstock (GB)

(21) Appl. No.: 15/499,208

(22) Filed: Apr. 27, 2017

Related U.S. Application Data
(60) Provisional application No. 62/328,541, filed on Apr. 27, 2016.

(51) Int. Cl. G06N 5/04

(52) U.S. Cl. CPC G06N 5/045; G06N 5/043

(57) ABSTRACT

A system and method that includes receiving a problem request and publishing the problem request through a computing platform; accepting a set of responses to the problem request during an ideation stage; at a similarity engine of the computing platform, consolidating the set of responses to a set of base responses; retrieving judgments on base response comparisons of the set of base responses during a judgment stage; and generating a response report for the problem request.

### CROSS-REFERENCE TO RELATED APPLICATIONS

This Application claims the benefit of U.S. Provisional Application No. 62/328,541, filed on 27 Apr. 2017, which is incorporated in its entirety by this reference.

### TECHNICAL FIELD

This invention relates generally to the field of decision-making tools, and more specifically to a new and useful system and method for automated decision making.

### BACKGROUND

Decisions are made all the time, and poor decisions can cost businesses, organizations, and individuals time, money, stress, and regret. Commercial systems have been built to facilitate the decision making process. Some commercial systems have used a process known as analytical hierarchical process (AHP) in evaluating different options. However, such systems are limited by the number of options that can be processed for a given question since considering each idea may increase the processing time in a non-linear fashion. Crude filtering like voting and other human polling interactions are sometimes used to simplify processing of ideas. The effect of these additional filtering processes is considerable delays, such that the decisions under consideration require the inefficient use of many people. Instead of normal decision time-frames being seconds, minutes, or hours, the systems require weeks or even months to reach tangible outcomes. Additionally, fully automated systems that rely heavily or entirely on algorithmic approaches reduce human participation, and thus may result in reduced user acceptance to the results. Thus, there is a need in the decision-making tools field to create a new and useful system and method for automated decision-making. This invention provides such a new and useful system and method.

### BRIEF DESCRIPTION OF THE FIGURES

FIG. 1 is a schematic representation of the system of a preferred embodiment;

FIG. 2 is a schematic representation of an exemplary problem request interface;

FIG. 3 is a schematic representation of an exemplary problem response interface;

FIG. 4 is a schematic representation of an exemplary response judgment interface;

FIGS. 5A and 5B are a schematic representations of exemplary reporting interfaces;

FIG. 6 is a flowchart representation of a method of a preferred embodiment;

FIG. 7 is a schematic representation of an implementation of a method of a preferred embodiment;

FIG. 8 is a schematic representation of each combination of a base response comparisons being distributed to each participant;

FIG. 9 is a schematic representation of base response comparisons distributed across participants;

FIG. 10 is a schematic representation of base response comparisons distributed across participants of corresponding participant classifications;

FIG. 11 is a flowchart representation of assigning a participant classification;

FIG. 12 is a schematic representation of consolidating exemplary responses; and

FIG. 13 is a flowchart representation of distributing pairwise judgments across participants.

### DESCRIPTION OF THE EMBODIMENTS

The following description of the embodiments of the invention is not intended to limit the invention to these embodiments but rather to enable a person skilled in the art to make and use this invention.

### 1. Overview

A system and method for automated decision making of a preferred embodiment can employ a distributed intelligence platform that manages a multi-stage process that involves collecting possible solutions from an audience for a given challenge, organizing the possible solutions into base options, and then obtaining a representative set of comparisons between the different base options. The system and method can use the comparisons in combination with response timing, participant profiles, and/or other factors to produce an output.

As one potential benefit, the system and method can promote participant ownership during problem resolution. While it is easy for a participant to feel that his or her voice was not heard during traditional polls or votes, the method can promote full participation at each stage. The method preferably operates while maintaining each unique idea within the process, which enables a large number of participants to submit ideas and have those ideas evaluated and considered. The method additionally includes a judgment stage that can use a comprehensive consensus of participants. Such mechanisms can enable participants to remain as stakeholders in the result.

As another potential benefit, the method can scale participation such that any suitable number of people can participate. As one aspect that can contribute to scalability, the system and method uses consolidation of base responses through automated natural language processing. For example, thousands of responses may be collected, but the system and method can avoid individual analysis by consolidating and reducing those responses to representative base responses that can more efficiently be analyzed by the available audience. Additionally, traditional approaches often place limits on the number of ideas to evaluate or the number of participants that can submit ideas, in part because evaluating ideas can scale at a nonlinear rate based on the number of ideas. There may traditionally be a lower limit of participation and an upper limit, which can severely limit the usefulness of these prior approaches. The method can operate efficiently while maintaining inclusive participation by the users. The method could be used by small groups. In some cases, the system could even work efficiently with a single participant that is self-evaluating different options. The method could similarly be used by large groups. For example, a large multinational corporation could deploy such a system and method in harnessing the collective intelligence of across their entire workforce.

As another potential benefit, the method can promote efficient resolution of a problem request. As one aspect, the use of time based restrictions and metrics can be used to limit the time to resolve problem. In many business situations, soliciting ideas from people can be an arduous task and very time consuming. The method can be used by an individual or a number of users and can be used synchronously or asynchronously.

As another potential benefit, the system and method may be applied in gathering and synthesizing group intuition. As one approach addressing such a potential benefit, the system and method can utilize timing for characterizing responses. For example, responses that gather faster reaction times during pairwise comparisons may provide useful insights in the intuition of participants.

There are numerous applications of the method. In one preferred application, the system and method is used as a form of crowd intelligence across a population of participants. As one exemplary use case, the method could be used within a business to leverage the intelligence of their work force to efficiently resolve issues. As another exemplary use case, the method could be used within organizations or governments to arrive at consensus on various issues.

In another preferred application, the system and method can be used in standardizing and automating the grading or evaluation of a large body of responses. For example, the system and method could be used in combination with an exam administered to a number of students. The system and method could then be used by educators to score and grade the body of answers in a consistent manner. Such response grading could similarly be used in employee recruiting or other areas where a volume of responses could benefit from a systematic approach for grading and comparing.

While there are numerous use cases where the method can be used within a group setting, the method may alternatively be used by an individual to evaluate his or her own thoughts to arrive at a decision.

Additionally, the system and method may be integrated with other systems. In one variation, the system and method can be integrated with a social networks and/or a knowledge base. In another variation, the system and method could be integrated with an artificial intelligence analysis platform for combining crowd intelligence with artificial intelligence.

### 2. System

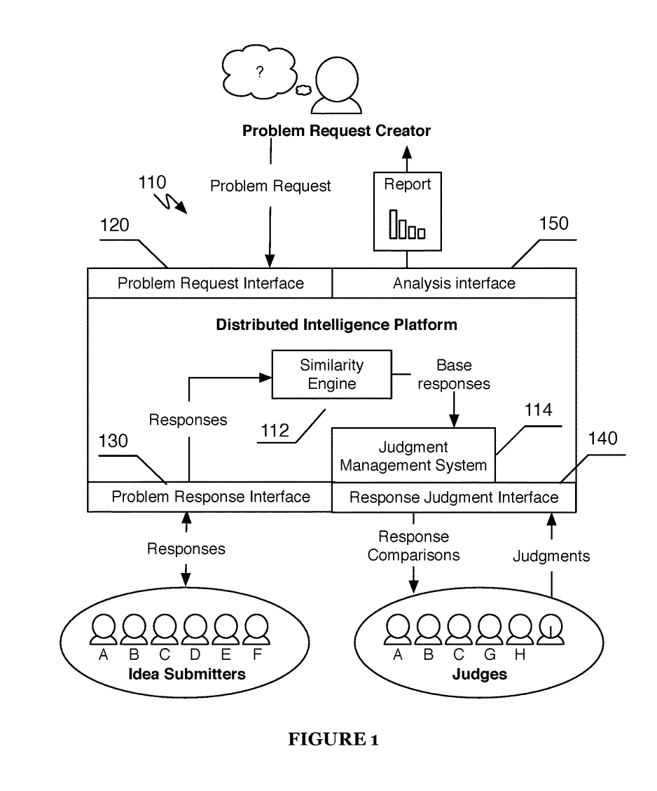

As shown in FIG. 1, a system for automated decision making of a preferred embodiment can include a distributed intelligence platform 110 with a problem request interface 120, a problem response interface 130, a response judgment interface 140, and a reporting interface 150. The system is preferably configured to execute and manage the method for a distributed intelligence process described herein. The distributed intelligence process is preferably includes multiple stages such as a challenge stage (e.g., for collecting problem or question), an ideation stage (e.g., for collecting ideas or possible solutions), a judgment stage (e.g., for assessing the ideas to identify one or more answer), and a reporting stage (e.g., applying results of the process).

The distributed intelligence platform 110 functions to manage user interactions and data processing. The distributed intelligence platform 110 is preferably implemented as network accessible web and/or native application, wherein multiple parties can participate with the distributed intelligence platform 110. Participants, administrators, and/or other users preferably access the distributed intelligence platform 110 through a web-based user application and/or a native application (e.g., an application operable on a personal computing device such as a phone). Alternative implementations could be a distributed system implementation wherein multiple devices collectively operate.

An account system and permission engine of the distributed intelligence platform 110 may be setup to permit user interactions with any suitable user scope. In one implementation, the distributed intelligence platform 110 can enable businesses to setup entity accounts wherein each entity account may have multiple participants register as users. In another implementation, the distributed intelligence platform 110 may be setup as a private system that operates within a private network of an entity.

The distributed intelligence platform 110 preferably includes a number of interfaces to facilitate the various stages of the distributed intelligence process, such as the problem request interface 120, the problem response interface 130, the response judgment interface 140, and the reporting interface 150. The various interfaces are primarily described as graphical user interfaces, but could alternatively or additionally include programmatic interfaces for integrating with outside digital systems. For example, responses may not be participant submitted but retrieved and provided through other outside services. Similarly, an API could be used to enable problem requests, problem responses, and/or judgments to be accessed from other channels. The interfaces could additionally be completed in part or in their entirety over communication protocols such as SMS/MMS, email, or other suitable forms of communication.

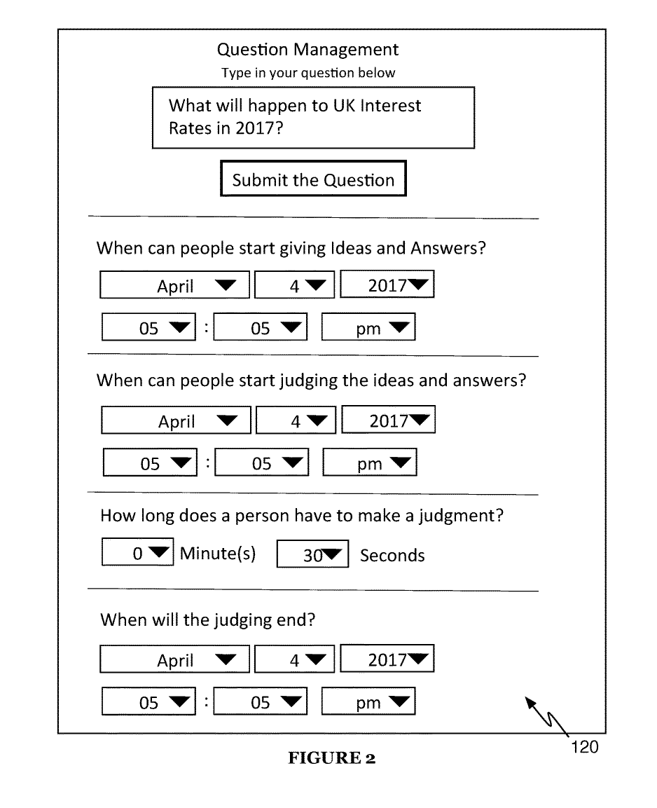

As shown in FIG. 2, the problem request interface 120 functions as the interface for acquiring problem requests. Problem requests are preferably submitted by one or more user. A problem request preferably includes a description and/or additional media and metadata.

A problem request could additionally be configured with target audience properties. Target audience properties can specify participation policy for specific participants and/or participant characteristics (e.g., company department, job title, geographic location, participant demographics, etc.). Participation policy can allow, require, or deny participation or set any suitable access rule for a participant during the distributed intelligence process. Participation policy can additionally be specified for particular stages of the distributed intelligence process.

A problem request can additionally include process properties, response properties, and/or comparison properties.

Process properties can include problem timing, which may include: scheduling when the problem request is distributed or published; limiting the duration of the various stages; setting other conditions on the stages such as number of response conditions or conditions for the number/volume of response comparisons; and/or other suitable settings. In one variation, the settings for the consolidation process applied to the collected responses can be configured. For example, the number of base responses can be limited to below a certain number.

Response property settings can include character, word, or other size limits; content properties; time window to submit a response; and/or other properties or rules relating to a response.

Comparison properties preferably relate to the judgment stage wherein responses are compared (preferably as pairwise comparisons). Comparison properties can alter the way base responses or their original source responses are presented. Comparison properties could also alter the type of responses such as allowing selection of only one, selecting prefer both, prefer neither, and/or other options.

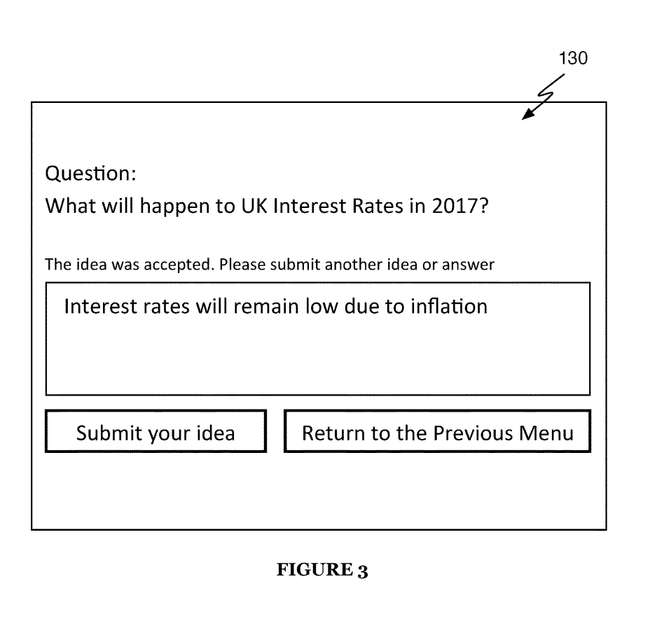

As shown in FIG. 3, the problem response interface 130 functions as an interface for collecting participant ideas. A problem response can be a potential answer, a solution, feedback, comment, and/or any suitable reply to the problem. Input elements are preferably provided to appropriately collect the problem response such as a text input, media input, or any suitable type of input. In one variation, the problem response interface 130 can enable multiple responses to a single problem request. In another variation, a participant can be limited to a single response.

In one variation, the timing of a supplied response may be used in limiting the duration to which a response can be provided and/or in measuring or otherwise scoring a response. For example, a timer may be displayed to indicate the amount of time. Other response content restrictions such as character or word limit can similarly be enforced through the problem response interface 130. More complex natural language restrictions such as sentiment analysis, topic analysis, and/or other forms of content patterns could similarly be applied through the problem response interface 130 (either directly in the interface or as a server-side validation process). In one implementation, the problem response interface 130 can include response autosuggesting where other supplied responses or generated responses can be displayed as a response is entered. Selection of an autosuggested response may be used in facilitating consolidation of responses and/or reduction of unique responses.

The problem response interface 130 preferably collects responses from one or more participants and submits them to the distributed intelligence platform no. The distributed intelligence platform 110 preferably includes a response processor 112 and judgment management system 114 used in processing and operating on the collected responses.

The response processor 112 functions to consolidate the responses to a set of base responses. The consolidation process can reduce substantially redundant or conceptually similar responses, which may simplify the number of responses that need analysis. The response processor 112 preferably applies natural language processing to group responses. Responses grouped together are described as base responses. The response processor 112 can additionally assign a base response representation (e.g., a description that can be displayed within the response judgment interface 140 in analysis of the various responses). In one variation, a base response representation can be one of the associated response options. In another variation, a base response representation can be a representative version of multiple response options. In one variation, hierarchical grouping may be performed so that there may be different levels of base responses.

In one variation, the distributed intelligence platform 110 can additionally include a base response management interface wherein base responses and their associated problem responses can be managed by an administrator. An administrator could edit base response representations. An administrator may also change the grouping of responses.

The judgment management system 114 functions to distribute base responses to participant instances of the response judgment interface 140 for comparison. The judgment management system 114 determines distribution or allocation of response comparisons so as to collect a representative sample of comparisons. In one variation, the comparisons can be randomly generated and assigned to participants. Alternatively, different comparisons may be selectively distributed according to participant properties. For example, pairwise comparisons may be distributed so as to collect judgment responses from a sample of participants with balanced properties (e.g., a balance of psychometric characteristics). Various pairwise comparisons are preferably distributed across participants that share a classification so that a representative view of that type of participant can be obtained (as opposed to characterizing the view of each individual participant. The distribution of responses for comparisons can additionally be dynamically adjusted based on collected judgments. For example, in evaluating many base responses, an initial round of comparisons may indicate a first subset of base responses with higher preference and a second subset of base responses with low preference. The first subset of preferences could then be distributed in more comparisons to increase statistical significance of those preferences. Additionally or alternatively, child base responses of the first subset of base responses could also then be explored to identify more specific response preferences.

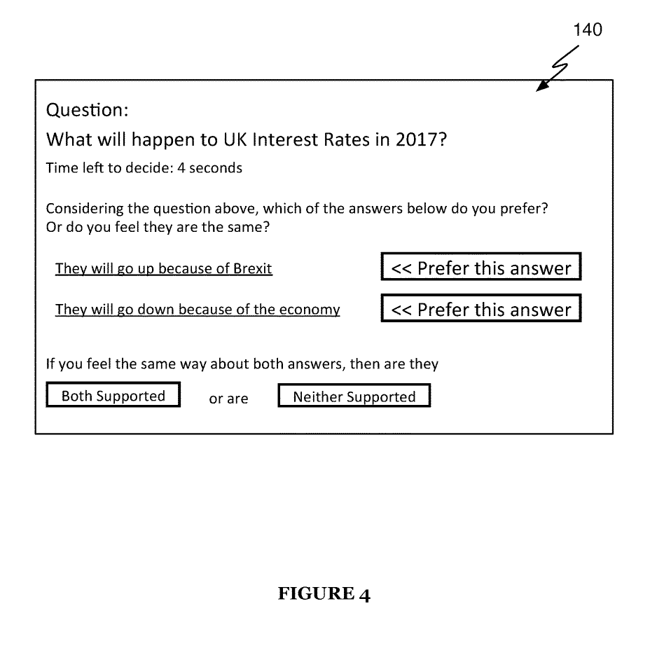

As shown in FIG. 4, the response judgment interface 140 functions to facilitate collection of comparisons between multiple response options. The response judgment interface preferably presents response options and solicits the participant to indicate their preference for the response. Preferably, responses are presented for pairwise comparison. Alternatively, a base response may be presented individually or as a group of three or more base response options. A participant can preferably select one or the other as a preferred response to the problem, select both as equally preferred options, select neither, or make any suitable response. The response judgment interface 140 can additionally collect other information such as participant comments, base response ratings, or other suitable forms of user input. The response judgments are preferably collected and then processed at the distributed intelligence platform 110.

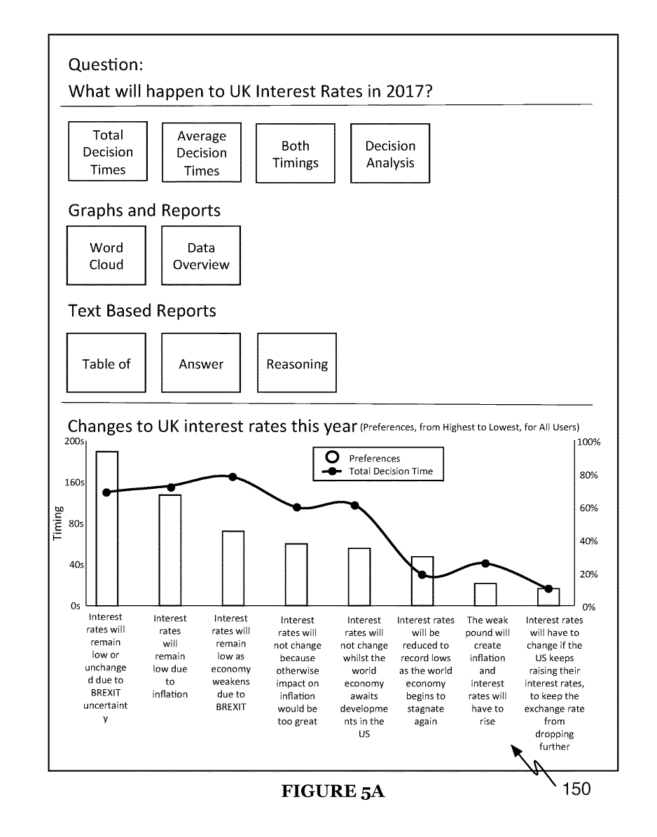

The reporting interface 150 functions to apply the results of the distributed intelligence process. The reporting interface 150 preferably provides a graphical report or multiple graphical reports as shown in FIGS. 5A and 5B. The report can indicate response rankings or preference levels. Response judgments could additionally be analyzed and explored according to various properties.

The system could alternatively apply the results of the distributed intelligence process in other ways. In one application, the system can be used as test answer scoring system. The distributed intelligence process can be used by educators in evaluating student responses for example. The system can include a system for automatically awarding of points to a responses based on collected judgment of the response (or base response) and assigning points to user test results. The system could additionally include a mechanism for identifying responses with low scoring confidence (e.g., responses that do not satisfy some condition for automatic scoring) and distributing an evaluation request to an evaluator for manual point assignment. The evaluation request can be accompanied by a response analysis to facilitate easier evaluation. For example, similar responses and assigned points may be supplied with the evaluation request.

### 3. Method

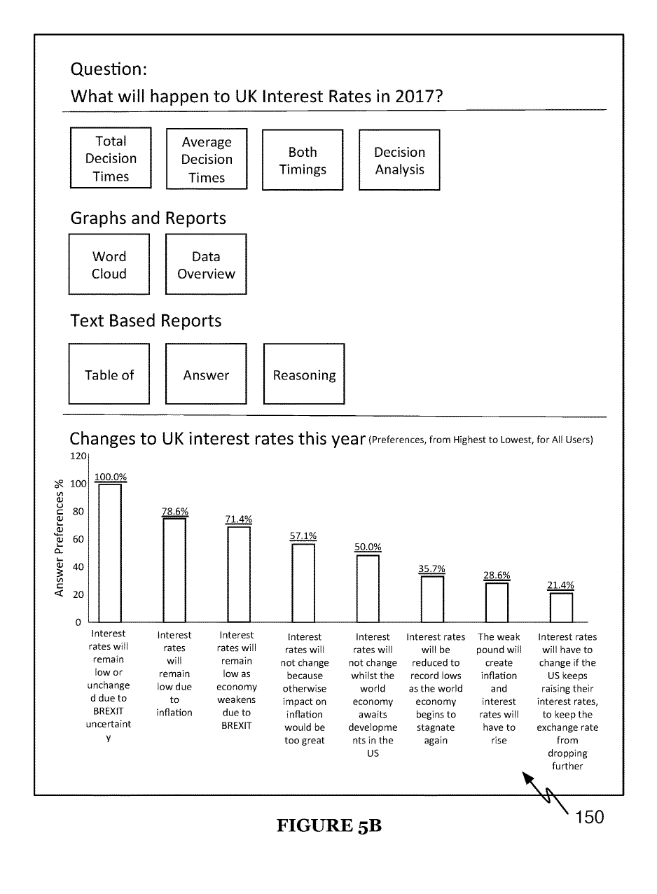

As shown in FIG. 6, a method for automated decision making of a preferred embodiment can include receiving a problem request S120, accepting a set of responses to the problem request during an ideation stage S130, consolidating the set of responses to a set of base responses S140, retrieving judgments on base response comparisons of the base responses during a judgment stage S150, and generating a response report for the problem request S160. The method functions to promote an efficient and inclusive approach to soliciting intelligence from a set of participants and making decisions. The method can utilize temporal constraints, natural language based consolidation of ideas, and/or participant classification based consolidation to expedite the process while maintaining participant engagement.

The temporal component of the method may be used to expedite the collection of responses and/or judgments and in evaluating the responses and/or judgments. Time metrics may be used in defining the initial solicitation of ideas and the individual judgment of each pair of unique ideas. In one variation, time windows can be set limiting the duration of one or more stage and when those windows occur. In another variation, responses can be timed or restricted to be completed by a participant within a time limit. For example responses may be limited to being answered within a certain time period, and/or judgments of base response comparisons may be forced to be made within a particular time window.

The natural language based consolidation of ideas may use a similarity engine to group solicited responses (e.g., ideas submitted by participants) so that the full set of responses may be more efficiently evaluated. Response consolidation can reduce or simplify the number of judged comparisons. Response consolidation can additionally be dynamically adjusted based on participation and results. For example, a large body of hundreds of results may initially be consolidated into ten ideas. Upon identifying a strong trend for preference for a limited number of the ideas (e.g., one to three of the base ideas), then judgment can be expanded to more detailed sub-base ideas of the limited number of ideas.

The participant classification based consolidation can use participant archetypes and classifications to balance or bias the represented viewpoint of the participants. Responses and/or judgments can be selectively solicited from participants. In one variation, the compared base responses presented to a participant are selected and matched together to get a representative perspective of that participant based on their classification. In this way, the method can leverage the diversity of a crowd in evaluating and ranking answers. Participant classification can be used for personality / psychometric classifications, organization classification, demographic classifications, and/or any suitable type of classifications.

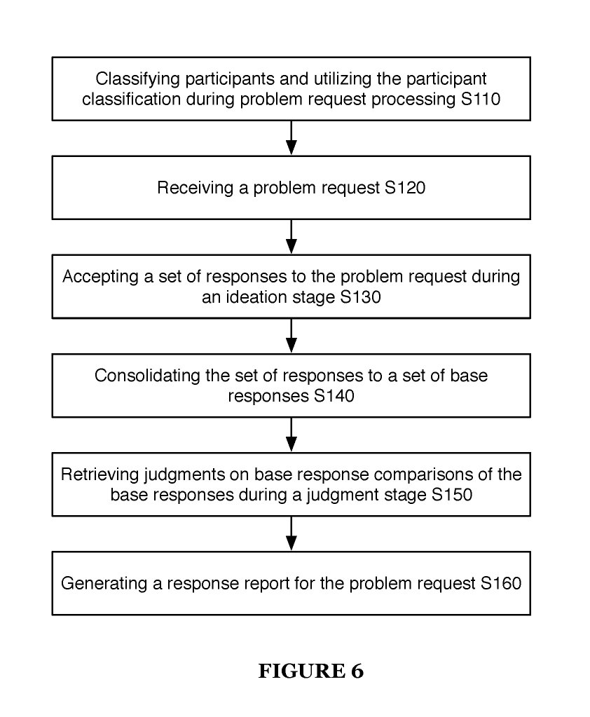

In a general implementation shown in FIG. 7, the method can involve a user submitting a question or challenge as a problem request. Participants provide their ideas as responses within the time restrictions that are configured for the problem request. The ideas are compared and automatically reduced to a base set of ideas where redundant or conceptually similar ideas are substantially consolidated to just one idea. The base set of ideas can then be used in presenting various pair-wise comparisons to participants (e.g., the same participants or different participants) and receiving the preference of the participant. Finally, a report can be generated for the problem request that may rank the ideas based on collected data from the process such as participant comparison preference, response times, participant weighting, and/or other suitable factors. Such a process can be streamlined and simultaneously inclusive.

The method is preferably implemented through a computer application system such as the one described above. The method can include providing the various view interfaces to facilitate implementation of the method. Additionally, user interactions may involve a request and response communication flow that is managed by a distributed intelligence platform. The computer application system can include a web-based application interface, a native application interface, and/or any suitable type of interaction interface. For example, in some cases, an implementation of the method may utilize a messaging service in soliciting and receiving questions, responses and/or judgments. The computer application system is preferably implemented in a cloud-based computing solution. The computer application system may alternatively be an on-premise application such as if a company wants to run a private instance of the application within their intranet. The computer application system preferably includes a user account system such that a variety of users can participate through their account. The computer application system in addition to facilitating implementation of the method can enforce policy on permissions of problem requests and/or user accounts. Problem requests and the participating user accounts may be restricted so that only particular user accounts can participate. For example, a problem request may be restricted to a defined list of participants or to participants associated with a particular business. Alternatively, problem requests may be made public so that any user account could participate. Additionally, permissions can be customized for who can submit problem requests, responses, and/or judgments. In one exemplary implementation of a user interface, a user may be presented with the option to create a problem request, provide their input in a response to a problem request, judge the comparison of responses for a problem request, and/or view results of a problem request.

In one variation, the method can additionally include classifying participants and utilizing the participant classification during problem request processing S110. Preferably participants are classified according to a psychometric classification. A psychometric classification is preferably a characterization of behavioral and/or personal traits of a participant. An example of a psychometric classification can include a Myers Briggs type classification, but any suitable type of psychometric classification may alternatively be used. Alternatively participants may be classified along alternative dimensions such as political stances, field expertise, skills, demographics, corporate or organization position (e.g., manager or employee), and/or other suitable classifications.

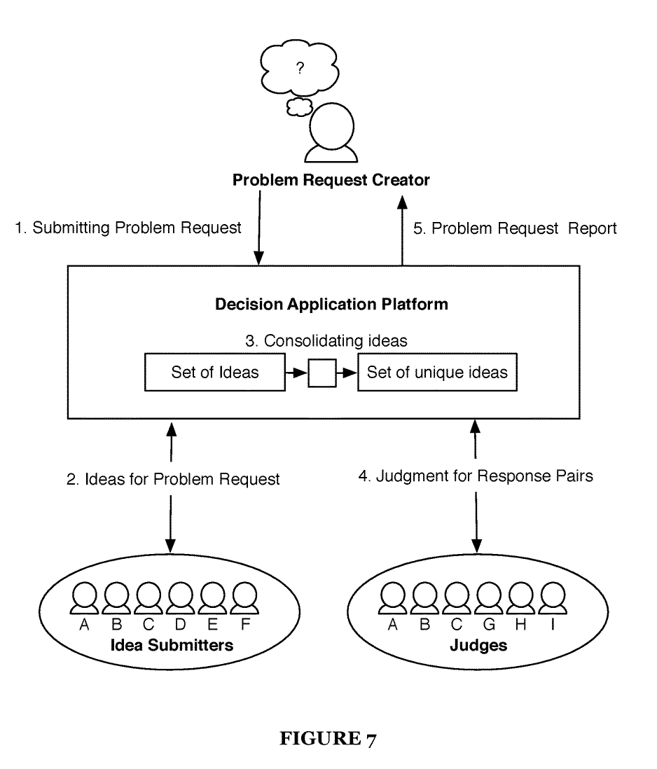

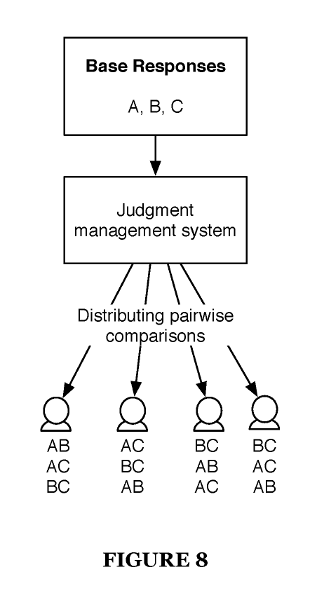

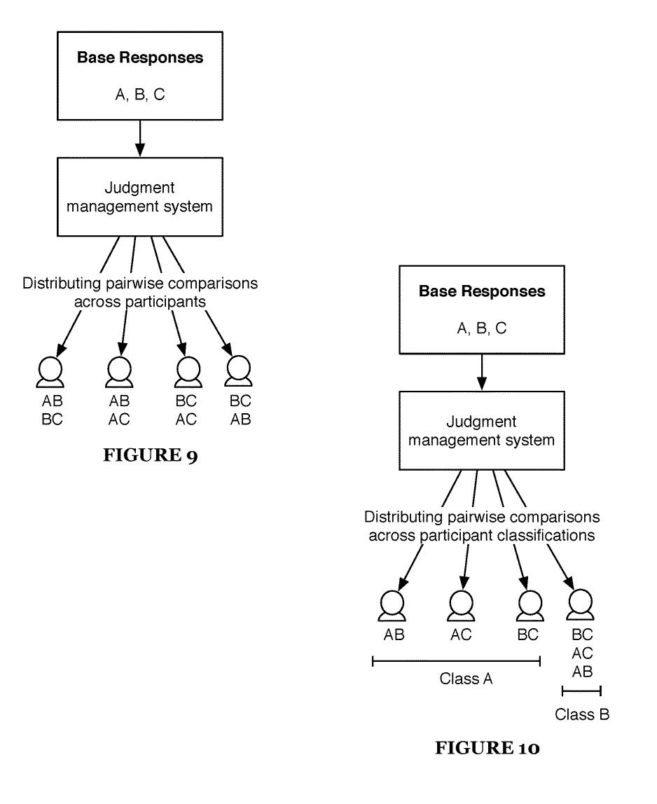

Participant classifications can function to partition participants and generalize participants within a group. This may be used in simplifying the complexity of the distributed intelligence process. In a preferred scenario, every participant can indicate their preference on every combination of base response comparisons as shown in FIG. 8. However, participant classifications can be used to reduce the number of comparisons to be completed by each participant—the full set of judgments desired from each participant can be distributed across participants as shown in FIG. 9. More specifically, those base response comparisons are distributed across participants of corresponding participant classifications as shown in FIG. 10.

Participant classification can additionally be used in generating a report in block S160.

In one variation, the manner of partitioning or classifying participants can be configurable aspect of a problem request. In one variation, the participant classification approach may be set during the configuration of a problem request.

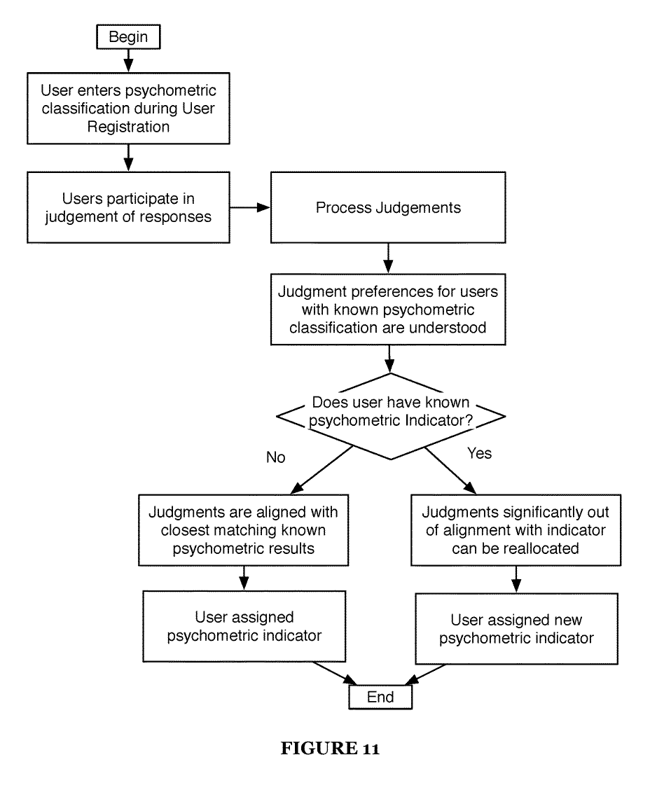

A participant classification may be manually assigned to a user, wherein block S110 may include receiving a participant classification. For example, if a user is aware of his or her Meyer Brigg's classification, the user could add that classification to a user profile. Additionally or alternatively, a participant classification may be generated or augmented through participant analysis. For example, the ideas and/or judgments of a participant may be compared to other participants, and the classification of a participant may be updated to group the participant with participants with similar behavior. Participant analysis and classification could additionally or alternatively be through participant usage of another platform such as user characteristics extracted from a social network profile or posts. As shown in FIG. 11, user-provided classification may be used in combination with automatic classification. If no classification is provided, a user may be automatically classified using existing data, wherein the automatic classification may be updated as more data is collected. In some embodiments the method may treat each user the same but other embodiments may utilize the participant classification in various ways during the method.

Preferably, utilizing the participant classifications can include retrieving participant input according to participant classification. Retrieving participant input based on participant classification can include requesting problem responses from a set of targeted participants, wherein the targeted participants are selected that satisfy a participant classification condition. A participant classification condition used in requesting/soliciting problem responses can be used to target participants across a diverse set of classifications. Alternatively, problem responses could be requested from a narrow focuses group of participants.

Retrieving participant input based on participant classification can additionally include assigning a set of base response comparisons to participants and selectively distributing the base response comparisons in connection to Block S150. This selective distribution can function to distribute judgments across the various participant classifications. The base response comparisons are preferably assigned or allocated to participants, wherein the full set of combinatorial combinations of base response comparisons is distributed across a subset of participants with a common participant classification. As discussed above, this can function to alleviate any requirements or preference for a single participant providing judgments of each possible combination. Dynamic assignment and distribution could similarly be used in targeting judgments by particular participants if their judgment is more highly valued.

The method can additionally dynamically retrieve participant input to fulfill various levels of participation from users of different classifications. The participant classifications can additionally be used in other aspects the method (e.g., Blocks S120, S130, S140, and S150).

Block S120, which includes receiving a problem request, functions to initiate problem request processing. The problem request is preferably submitted by a participant and received through a problem request interface such as the one described above. Alternatively, problem requests may be automatically generated.

A problem request preferably includes receiving a primary objective in the form of a question, challenge, problem statement, or other form of problem to an audience. The primary objective can be presented in a textual format, media format, or a multi-media format. In some cases, the primary objective may be concisely presented (e.g., less than 500 characters), and in other cases, the primary objective may include a detailed explanation of the problem with supplementary media attachments for reference.

The primary objective may additionally be processed and/or validated. One processing task may validate that the problem request satisfies particular requirements such as length, language, sentiment (e.g., identify negative, aggressive, or problematic content), and/or other conditions. Another processing task may be to identify similar or related problem request such that they can use the existing or active problem request instead.

Receiving a problem request can additionally include setting properties of the problem request. The properties of the problem request can include ideation stage properties and judgment stage properties. The problem request can additionally or alternatively use other suitable properties used in configuring an instance of problem request processing.

The ideation properties can include temporal properties such as a process start time and a process end time that define when the problem request is open and available for solicitation of responses. In one variation, different segments of participants may be given different time windows for submitting responses. The ideation properties can additionally include participant properties that set which users can submit responses. The ideation properties may additionally include response volume properties. Response volume properties can set conditions based on the number of responses. Response count could be in raw received responses but could alternatively be measured by number of consolidated base responses. For example, a minimum threshold on the number of unique base responses could be used to determine when the ideation stage closes. Volume properties may be used in combination with or as an alternative to the temporal properties. For example, a problem request could be open for one week or until a set number of responses are received. Another ideation property could be individual response time limits. In one variation, ideas submitted as responses may be limited to being submitted within a particular time window, which functions to promote more spontaneous and intuitively submitted responses.

The judgment stage properties can include temporal properties that similarly define when the judgment stage is open and closed. A judgment temporal property may additionally define the amount of time a judgment may be made on a particular pair-wise comparison. The judgment stage properties can additionally include audience properties that can be used to define how retrieval of judgments is distributed across an audience. In one preferred variation, judgments may be distributed across an audience according to psychometric classifications of the participants. The judgment stage properties can additionally include volume properties. In one variation a minimum number of judgments can be set, and the judgment stage can be kept open until at least the minimum number of judgments are achieved.

A problem request can additionally be configured with a reward setting. In some variations, monetary or virtual rewards may be granted for particular actions relating to a problem request. Setting of rewards may enable an entity posing the problem request to incentivize participation.

The method preferably includes publishing the problem request through the computing platform, which functions to distribute the problem request to a set of participants. In one variation publishing can involve making the problem request publicly available or accessible to permitted participants. Publishing can additionally include transmitting problem requests to a set of targeted participants. In this way, particular participants can be actively solicited to participate. Transmitting a problem request can include sending an SMS/MMS, a push notification, an email, a phone call, and/or any suitable type of communication.

Block S130, which includes accepting a set of responses to the problem request during an ideation stage, functions to obtain a set of ideas, thoughts, opinions, answers, evaluations, and/or other suitable types of responses to the problem request. The method is preferably configured to substantially maintain the entire set of responses. Spam, fraudulent or particularly low quality responses may be automatically filtered.

The ideation stage is preferably conditionally maintained according to configuration of the problem request. The ideation stage is preferably open during a time period and for an audience as configured during block S120. In one variation, block S120 can include configuring a response time limit and block S130 can include, for each response, enforcing the response time limit within a problem response interface. This variation can function to encourage participants to more spontaneously provide ideas.

A response is preferably a textual answer, but it may alternatively be any suitable format such as a multimedia response. Preferably, a user can voluntarily supply a response. For example, the user may see a post soliciting responses to a question on the application website, and the user can open the post to add his or her response. Alternatively, a user may be actively requested to supply a response. For example, once a problem request is made, a set of participants may receive a notification via email, push notification, SMS/MMS, or another suitable communication channel. An organization, team, or business may actively solicit participation from particular users for problems that could benefit from fuller participation. In one variation, the computer application system includes an application programming interface (API) such that outside services and applications integrate with the system and supply responses.

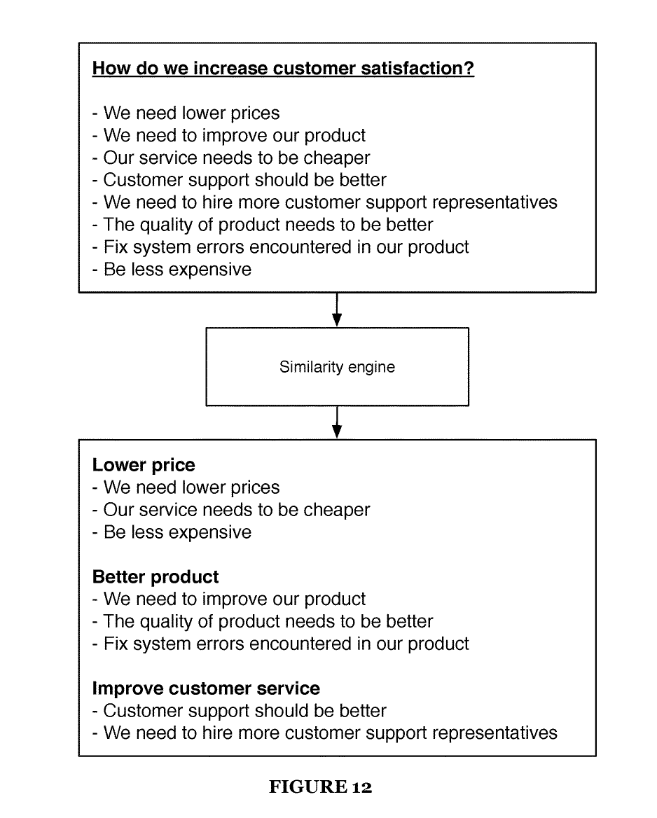

Block S140, which includes consolidating the set of responses to a set of base responses, functions to reduce substantially redundant or similar responses and group them together. Consolidating the set of responses to a set of base responses preferably includes grouping responses of similar concepts and assigning a base response representation as shown in FIG. 12. The base response representation is presented to participants in the base response comparison of Block S150. A similarity engine preferably processes the set of responses. The similarity engine can use natural language processing, machine learning, and/or alternative algorithmic techniques to group similar responses. The full set of responses represent each submission (i.e., valid submission) during the ideation stage, and the set of base responses represent a limited number of submissions that (according to the similarity engine) account for the main or unique concepts represented in the full set of responses. In one variation, consolidating of the set of responses can be configured to promote more or fewer base responses. For example, a user during block S120 may set the problem response processing to use a more aggressive similarity comparison process to arrive at a conclusion faster. Additionally, the method may enable user review of the set of responses and/or the base responses.

In one variation, block S140 can include updating the set of base responses as directed by a user edit. An administrator of the problem request may edit or adjust the sets of responses and/or base responses. For example, responses grouped together as a single base response may be split into two or more distinct base responses. Similarly, multiple base responses can be combined. Changes to base responses preferably occur before a judgment stage, but could alternatively or additionally be performed during the judgment stage. In one variation, a participant may mark a response as being similar to another response. For example, a response judgment interface can include an option to mark the two base responses as being conceptually similar, which may then be used to augment the grouping of the base responses.

A base response can include one or more associated responses. In one variation, grouping of responses can be hierarchically structured such that a base response can include a child base response. Hierarchical consolidation may be used in dynamically adjusting the consolidation of base responses during a judgment stage.

A representation of a base response is preferably used when presenting the base response in the judgment stage. The representation can be algorithmically generated, selected from the group of associated responses, manually supplied, and/or provided in any suitable manner

In one algorithmically generated variation, a consolidated version of a base response representation can be algorithmically selected from the associated responses based on a natural language scoring of the responses. The selected response can then be used as the representative of the base response. The method may prioritize particular response properties such as brevity, clarity, grammar, and/or other factors. The selected response may additionally be selected based on having the highest similarity score to the other associated responses.

In another algorithmically generated variation, the consolidated version of a base response representation may be automatically generated from at least a subset of the set of similar responses. For example, the base response may be a generated response including content from multiple responses.

In yet another variation, the base response representation may be selected based on outside factors. For example, a response may be selected based on which user has the highest priority, where priority may be based on factors such as participation, expertise, job function, or account settings.

The base response representation may alternatively be randomly or otherwise selected as the representative response wherein the presented base responses can vary between different instances of a base response comparisons. For example, in the comparison of base response A and base response B, different participants may see different responses representing A and B. When a base response is used in a base response comparison, one response from the associated responses is selected to be the base response representation used in that instance of a comparison such that more responses may be shown during the judgment. The selection may be random, ordered, or use any suitable prioritization.

Block S150, which includes retrieving judgments on base response comparisons of the base responses during a judgment stage, functions to allow one or more participants to state their opinion on how the various responses compare. The base response comparisons are preferably pairwise comparisons. Pairwise comparisons are preferably used because a participant may more easily distinguish their preference when given two options. Alternative implementations may allow more options to be presented for a given judgment. In yet another alternative implementation, a judgment may be made for an individual response. In another variation, the number of base response options can be variable for different comparisons distributed to participants. In one variation of variable options, the number of base response options could be randomly selected. In another variation of variable options, the number of base response options could be incrementally reduced as judgment data is collected and used to identify higher preference base response options, which may function to more quickly eliminate/filter out low preference options or conversely identify higher preference options. Herein, the method is primarily described as providing two response options during an individual judgment, but this is not intended to limit comparisons to only two options.

A judgment is preferably collected user input that characterizes user preference. The judgment is preferably collected through a response judgment interface and then communicated to the distributed intelligence platform.

A judgment can indicate a participant's preference for one of the response options, for both of the response options, neither of the response options, and/or no opinion. Accordingly, retrieving judgments can include receiving user preference of one or more base response of the base response comparison (e.g., selection of one, both, or neither). A judgment could additionally include comments, ratings of one or more options, or any other suitable mechanisms for characterizing a judgment. For example, a participant may indicate if they strongly prefer the first option, somewhat prefer with a first option, hold no preference, somewhat prefer the second option, or strongly prefer the second option.

Retrieving judgments preferably includes timing the response time of a participant for each judgment. The time taken to decide between two options may be a signal for the strength of a participant's judgment. If a participant answers quickly that may indicate that the decision is easy so that the response may be weighted more strongly. The response times of judgments can then be applied in generating the response report of block S160 wherein S160 can include weighting participant judgment responses in part by duration of participant judgment responses. Other forms of a time limitation during the judgment stage can include enforcing a judgment time limit on a judgment of a participant. The judgment time limit can be configured for the problem request in block S120. For example, participants may be limited to selecting their preference within 30 seconds of base response options being presented.

While the method may prefer each participant to provide judgment on a full set of base response comparisons, the method can account for participants only providing judgment for a subset of the possible base response comparisons.

In one variation, base response comparisons may be randomly assigned and distributed across participants. In another variation, the full set of possible base response comparisons can be queued for distribution (preferably in a random or in an order to avoid judgment biasing) and then sequentially distributed as the judgment response interfaces request new base response comparisons for judgment.

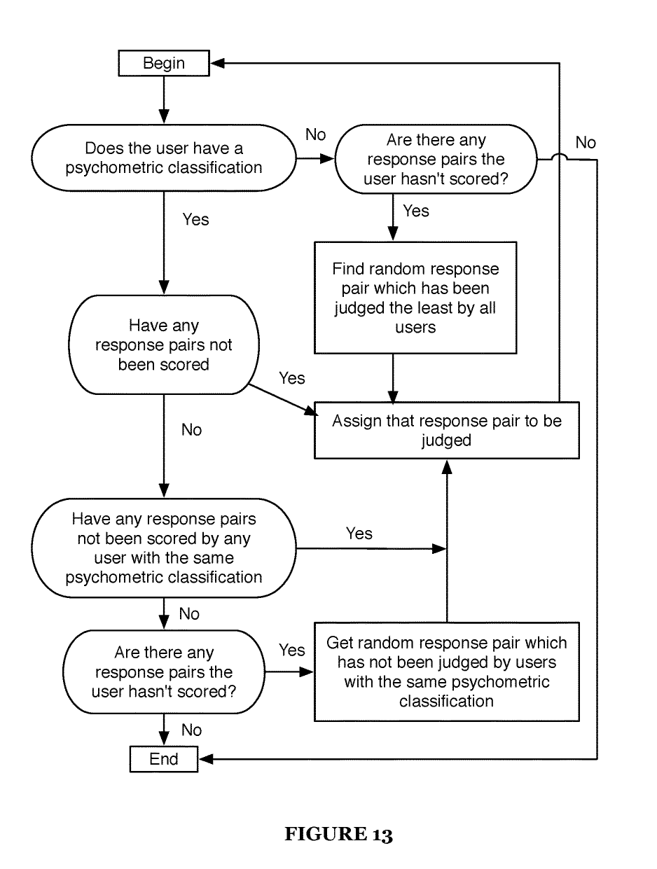

Preferably, response comparisons are distributed across the possible comparisons to balance or at least avoid systematic biases through basic ordering of the comparisons. When users have a participant classification, the response comparisons may be distributed to participants so as to balance input across all participants and participants within a classification as shown in FIG. 13. When a participant is providing numerous judgments, the distribution of the response comparisons can be randomized (e.g., do you prefer option: B or D? A or B? B or C? A v C? C or D? A v D?) such that the participant preferably will not experience a systematic sequential ordering of response comparisons (e.g., do you prefer option: A or B? A v C? A v D? B or C? B or D?C or D?).

In one implementation of distributing base response comparisons, retrieving judgments can include selectively distributing base response comparisons across participants according to participant classification. Participant classifications that can impact distribution can include personality/psychometric classifications, organization classification, demographic classifications, and/or any suitable type of classifications. In one example, for each participant classification, the full set of comparisons can be distributed across participants of the same participant classification.

For a given participant providing judgments, base responses can be selected for comparison in response to base response comparisons previously or currently selected or distributed to participants of the same classification. This may function to normalize or balance judgments across different classifications. Various measurements or rules of participant classification representation may be used in balancing distribution. In one example, base response comparisons could be distributed across different participants based on participant psychometric classification, which can function to balance representation of different personality types. In another example, base response comparisons can be distributed across different participants based on organizational classification (e.g., manager, junior associate, etc.). The distribution can be set to be balanced. Alternatively, the distribution across participants can be biased to collect more judgment input from one or more classification.

Block S160, which includes generating a response report for the problem request, functions to process the judgments to produce a result. The response report is preferably a characterization of the various responses based on the retrieved judgments. The response report can be a static document but may alternatively be an interactive dashboard for exploring the results. The response report preferably includes a prioritized list of the set base responses. The base responses are preferably ordered according to the results of the judgment stage. Responses can be scored during the judgment stage based on the set of judgments across multiple pairwise comparisons. For individual judgments, the time to respond may be used to weight or augment how that judgment is evaluated. The results of the judgments may include participant normalization. For example, the results of the judgments may be normalized across participant classifications. If the full set of judgments includes more judgments from one participant classification than a second participant classification, the various responses may be normalized to balance representation of the various participant classifications. Any suitable ranking processing may additionally or alternatively be used.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A method comprising:
receiving a problem request and publishing the problem request through a computing platform;
accepting a set of responses to the problem request during an ideation stage;
at a similarity engine of the computing platform, consolidating the set of responses to a set of base responses;
retrieving judgments on base response comparisons of the set of base responses during a judgment stage; and
generating a response report for the problem request.

2. The method of claim 1, further comprising classifying participants.

3. The method of claim 2, wherein classifying participants comprises receiving a participant psychometric classification.

4. The method of claim 3, wherein retrieving judgments further comprises selectively distributing base response comparisons across participants according to participant psychometric classification.

5. The method of claim 1, wherein retrieving judgments comprises timing duration of a participant judgment response; and wherein generating the response report comprises weighting recording participant judgment responses in part by duration of participant judgment responses.

6. The method of claim 1, wherein receiving the problem request comprises configuring a judgment time limit; wherein retrieving a judgment comprises enforcing the judgment time limit on a judgment of a participant;

7. The method of claim 1, wherein receiving the problem request comprises configuring a response time limit; wherein accepting a set of responses to the problem request comprises, for each response, enforcing the response time limit within a problem response interface.

8. The method of claim 1, further comprising updating the set of base responses as directed by user edit.

9. The method of claim 1, wherein the base response comparisons are pairwise comparisons between two base responses.

10. The method of claim 1, wherein the base response comparisons are comparisons of at least three base responses.

11. The method of claim 1, wherein retrieving judgments on base response comparisons comprises selectively distributing the base response comparisons to participants, wherein the base response comparisons have a variable number of base response options.

12. The method of claim 1, wherein consolidating the responses to a set of base responses comprises generating a consolidated version of each base response, wherein the consolidated version is presented during base response comparisons.

13. The method of claim 1, wherein during a judgment stage, selectively presenting a response associated with each base response of the base response comparison.

14. The method of claim 1, further comprising transmitting a notification of the problem request to targeted participants; and wherein at least a subset of the responses are accepted from a subset of the targeted participants.

15. A method for automated decision making comprising:
receiving a problem request through a user interface of a computing platform;
publishing the problem request to set of participants;
accepting responses to the problem request during an ideation stage;
at a language processing engine of the computing platform, consolidating the responses to a set of base responses, wherein a base response is a group of responses classified as similar response types;
distributing pairwise comparisons of base responses across participants through a response judgment interface;
retrieving judgment responses from the participants comprising timing a response time of each judgment response; and
generating a response report of the problem request that ranks base responses by judgment responses, wherein the ranking is partially weighted by a response time.

16. The method of claim 15, further comprising:
classifying participants into a set of participant classifications;
wherein distributing pairwise comparisons of base responses across participants comprises distributing pairwise comparisons of base responses across participant classifications.

17. A system for automating distributed intelligence comprising:
a computing platform comprising:
a problem request interface that is configured to receive a problem request,
a problem response interface that is configured to accept a set of responses to the problem request,
a similarity engine configured to consolidate the set of responses to a base responses
a response judgment interface that is configured to retrieve judgments on comparisons of the base responses, and
an analysis interface configured present a response report of the problem request that ranks base responses by judgment responses;

18. The system of claim 17, wherein the comparisons of the base responses are pairwise comparisons.

19. The system of claim 18, further comprising a judgment management system configured to distribute the comparisons of the base responses across participants that share a classification.
